(19) United States
(12) Patent Application Publication
(10) Pub. No.: US 2017/0031498 A1
(43) Pub. Date: Feb. 2, 2017

(54) TOUCH CONTROL ELECTRONIC DEVICE AND CONTROL METHOD THEREOF

(71) Applicant: MStar Semiconductor, Inc., Hsinchu Hsien (TW)

(72) Inventors: Chi-An Jen, Zhubei City (TW); Peng-Yun Ding, Zhubei City (TW)

(21) Appl. No.: 15/201,879

(22) Filed: Jul. 5, 2016

(30) Foreign Application Priority Data
Jul. 31, 2015 (TW) 104124882

(51) Int. Cl. G06F 3/041; G06F 3/0488; G06F 3/044

(52) U.S. Cl. CPC G06F 3/0416; G06F 3/044; G06F 3/04886; G06F 2203/04113

(57) ABSTRACT

A touch control electronic device includes a main display region, a touch sensing electrode group and a control module. The main display region is disposed at a front face of the touch control electronic device. The touch sensing electrode group is disposed on a lateral side of the touch control electronic device. The control module generates a sensing result according to a condition of the touch sensing electrode group being touched. In a first operation mode, the control module generates a first action determination result according to a first virtual key configuration and the sensing result. In a second operation mode, the control module generates a second action determination result according to a second virtual key configuration and the sensing result.

This application claims the benefit of Taiwan application Serial No. 104124882, filed Jul. 31, 2015, the subject matter of which is incorporated herein by reference.

### BACKGROUND OF THE INVENTION

Field of the Invention

The invention relates to a touch control electronic device.

Description of the Related Art

In a current portable electronic device, such as a mobile phone, a tablet computer or an electronic game console, apart from main human-machine interfaces (HMI) such as a keypad, a display and a touch screen located in the front of the device, mechanical keys or rotatable buttons offering functions including power switch, volume adjustment and mode switching are additionally provided on a lateral side of the device. One drawback of such mechanical interfaces is that, liquid is likely to seep through seams between the keys or rotatable buttons and a main body of a housing of the electronic device into the housing. In other words, the additional keys or rotatable buttons provided on the lateral side of a portable electronic device are attributes to user-friendly interfaces, yet degrade the overall waterproofness of the portable electronic device, resulting in a rise of the malfunction rate. On the other hand, restrained by intrinsic properties of mechanical components, physical buttons or rotatable buttons offer invariable quantity, position and operation method after they are manufactured, hence allowing almost no flexibility for subsequent adjustments.

### SUMMARY OF THE INVENTION

The invention is directed to a touch control electronic device and a control method thereof. By implementing a virtual key on a lateral side of an electronic device using a touch sensing electrode group, the electronic device of the present invention provides better waterproofness and design flexibilities as opposed to conventional mechanical keys.

A touch control electronic device is provided according to an embodiment of the present invention. The touch control electronic device includes a main display region, a touch sensing electrode group and a control module. The main display region is disposed at a front face of the touch control electronic device. The touch sensing electrode group is disposed on a lateral side of the touch control electronic device. The control module is coupled to the touch sensing electrode group, and generates a sensing result according to a condition of the touch sensing electrode group being touched. In a first operation mode, the control module generates a first action determination result according to a first virtual key configuration and the sensing result. In a second operation mode, the control module generates a second action determination result according to a second virtual key configuration and the sensing result. The second virtual key configuration is different from the first virtual key configuration.

A control method for a touch control electronic device is further provided according to an embodiment of the present invention. The touch control electronic device includes a main display region and a touch sensing electrode group. The main display region is disposed at a front face of the touch control electronic device. The touch sensing electrode group is disposed on a lateral side of the touch control electronic device. A sensing result is generated according to a condition of the touch sensing electrode group being touched. In a first operation mode, a first action determination result is generated according to a first virtual key configuration and the sensing result. In a second operation mode, a second action determination result is generated according to a second virtual key configuration and the sensing result. The second virtual key configuration is different from the first virtual key configuration.

A touch control electronic device is further provided according to an embodiment of the present invention. The touch control electronic device includes a touch sensing electrode group and a control module. The touch sensing electrode group is disposed on a lateral side of the touch control electronic device, and includes a first sensing electrode and a second sensing electrode that are adjacent by a gap in between. Each of the first sensing electrode and the second sensing electrode is a claw-like electrode. A claw width of the first sensing electrode gradually reduces along a predetermined direction. A claw width of the second sensing electrode gradually reduces along a direction opposite the predetermined direction. The control module is coupled to the first sensing electrode via one single first sensing wire, and is coupled to the second sensing electrode via one single second sensing wire. The control module generates a sensing result according to a condition of the touch sensing electrode group being touched.

A touch control electronic device is further provided according to an embodiment of the present invention. The touch control electronic device includes a touch sensing electrode group and a control module. The touch sensing electrode group is disposed on a lateral side of the touch control electronic device, and includes a first sensing electrode and a second sensing electrode that are adjacent by a gap in between. The control module is coupled to the touch sensing electrode group, and generates a sensing result according to a condition of the touch sensing electrode group being touched.

According to a mutual capacitance value between the first sensing electrode and the second sensing electrode, the control module determines whether to cause the touch control electronic device to enter a mist mode.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1(A) is an appearance schematic diagram of a touch control electronic device according to an embodiment of the present invention;

FIG. 1(B) and FIG. 1(C) are two examples of a virtual key configuration according to the present invention;

FIG. 2 is a schematic diagram of a relationship of a control module, a touch sensing electrode group and a backend circuit according to the present invention, and an exemplary function block diagram in a control module according to the present invention;

FIG. 3 is an exemplary front appearance diagram of a touch control electrode device according to the present invention;

FIG. 4(A) and FIG. 4(B) are examples of a touch sensing electrode group including two sensing electrodes based on self-capacitive touch control technologies according to an embodiment of the present invention;

FIG. 5 is a flowchart of a control method for a touch control electronic device according to an embodiment of the present invention; and

FIG. 6(A) and FIG. 6(B) are exemplary operation processes of an action determination unit in two different operation modes according to the present invention.

### DETAILED DESCRIPTION OF THE INVENTION

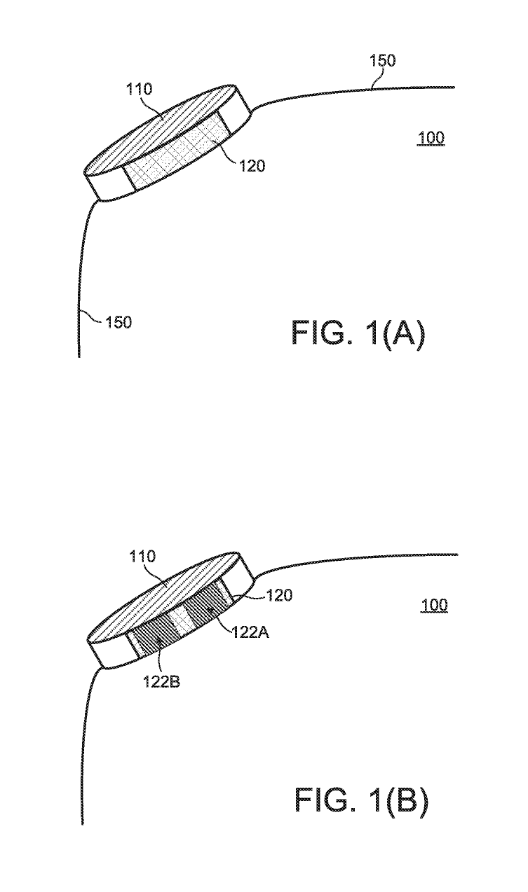

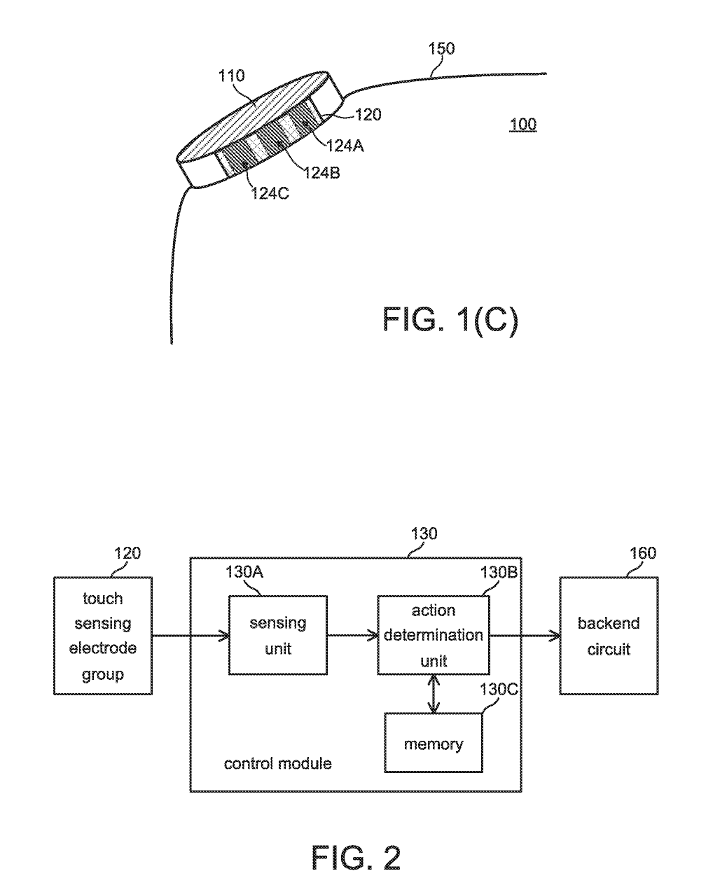

FIG. 1(A) shows an appearance schematic diagram of a touch control electrode device according to an embodiment of the present invention. It should be noted that, an example of a wearable electronic device worn at a wrist of a user given in FIG. 1(A) is for explaining the present invention, rather than limiting the scope of the present invention. Through the description below, one person skilled in the art can understand that, the touch control electronic device according to the present invention may be a mobile phone, a tablet computer or an electronic game console, or other types of wearable electronic devices. Further, the touch control electronic device may be an independent device, or may be integrated into various kinds of electronic systems needing the touch function.

Referring to FIG. 1(A), the touch control electronic device 100 includes a main display region 110, a touch sensing electrode group 120, a control module (located in the touch control electronic device 100, not shown), and a wristband 150. The main display region 110 is disposed in the front of the touch control electronic device 100. For example, the main display region 110 may include a display and/or a touch screen of the touch control electronic device 100, and includes a plurality of main display region sensing electrodes. The touch sensing electrode group 120 is disposed on a lateral side of the touch control electronic device 100. In practice, the touch sensing electrode group 120 may include multiple smaller sensing electrodes, e.g., multiple sensing electrodes based on self-capacitive touch control technologies.

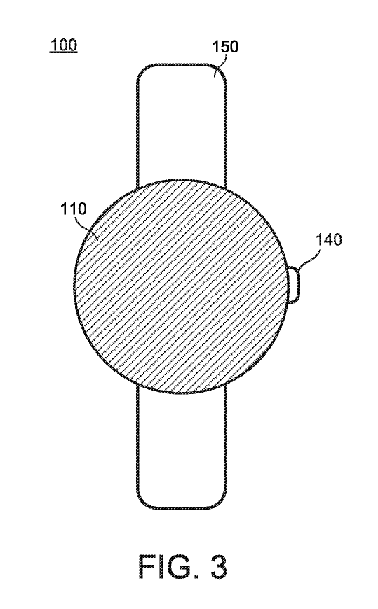

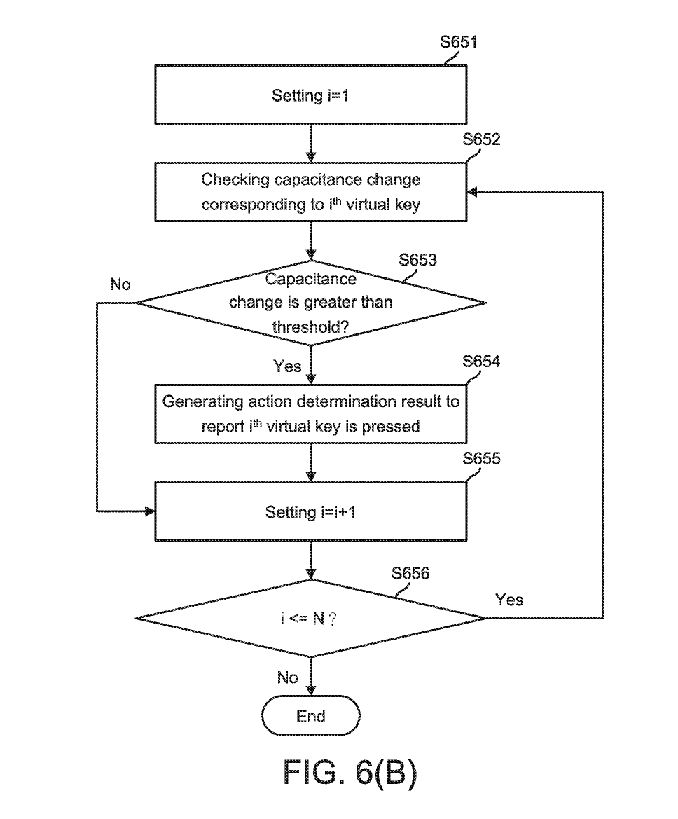

FIG. 2 shows a schematic diagram of a relationship of the control module 130, the touch sensing electrode group 120 and a backend circuit 160. For example, the backend circuit 160 may be a controller for display components of the touch control electronic device 100, or a controller in charge of operating an operating system of the touch control electronic device 100. As shown in FIG. 2, the control module 130 is coupled between the touch sensing electrode group 120 and the backend circuit 160. FIG. 2 further shows an exemplary function block diagram in the control module 130. The control module 130 includes a sensing unit 130A, an action determination unit 130B and a memory 130C. The sensing unit 130A generates a sensing result according to a condition of the touch sensing electrode group 120 being touched. The action determination unit 130B generates an action determination result according to the sensing result and an operation mode of the touch control electronic device 100 to the backend circuit 160. Taking self-capacitive touch control technologies for example, the sensing unit 130A may include multiple operational amplifier circuits for detecting capacitance changes of the electrodes in the touch sensing electrode group 120. When the capacitance change of one of the electrodes is higher than a self capacitance threshold, the sensing unit 130A determines that the electrode is touched by a user. The physical position of each of the electrodes is fixed and known. The sensing result that the sensing unit 130A provides to the action determination unit 130B may include position information of a touch point and the value of the capacitance change. An example of operations of the action determination unit 130B will be given in detail with reference to FIG. 6(A) and FIG. 6(B) later.

The touch control electronic device 100 provides flexibilities of supporting multiple operation modes. For example, in different operation modes, the control module 130 may determine how to respond to a user touch according to different virtual key configurations. In this embodiment, when the sensing unit 130A outputs a sensing result, if the touch control electronic device 100 is in a first operation mode, the action determination unit 130B generates a corresponding first action determination result according to a first virtual key configuration and the sensing result. In contrast, when the sensing unit 130A outputs a sensing result, if the touch control electronic device 100 is in a second operation mode, the action determination unit 130B generates a second action determination result according to a second virtual key configuration (different from the first virtual key configuration) and the sensing result. Thus, in different operation modes, the same sensing result may produce different action determination results. It should be noted that, the touch control electronic device 100 may be designed to have more than two operation modes and more than two virtual key configurations. Further, each virtual key configuration may be designed to have one or more differences in the quantity, function, size, position and trigger method (single-click, double-click and sliding along a predetermined direction) of the virtual keys.

FIG. 1(B) shows an exemplary virtual key configuration according to the present invention. The virtual key configuration depicted in FIG. 1(B) includes two virtual keys 122A and 122B, which respectively cover two different sub-regions of the touch sensing electrode group 120. For example, assume that the touch control electronic device 100 provides both sound playback and message display functions. When the touch control electronic device 100 is in a music playback mode (the first operation mode), the virtual keys 122A and 122B (the first virtual key configuration) are set to correspond to functions of “increase the volume” and “decrease the volume”, respectively. That is to say, in the music playback mode, if the sensing result generated by the sensing unit 130A indicates that the user touches a region where the virtual key 122A of the touch sensing electrode group 120 is located, the action determination unit 130B generates an action determination result to the backend circuit 160 to inform that the virtual key 122A is touched, such that the backend circuit 160 increases the volume of the touch control electronic device 100. In contrast, in the music playback mode, if the sensing result generated by the sensing unit 130A indicates that the user touches a region where the virtual key 122B of the touch sensing electrode group 120 is located, the action determination unit 130B generates an action determination result to the backend circuit 160 to inform that the virtual key 122B is touched, such that the backend circuit 160 decreases the volume of the touch control electronic device 100. When the touch control electronic device 100 is in a message display mode (the second operation mode), the virtual keys 122A and 122B may be set to correspond to functions of “display the previous message” and “display the next message”, respectively. For another example, assuming that the main display region provides a function of image display. When the touch control electronic device 100 is in the image display mode (a third operation mode), the virtual keys 122A and 122B that are triggered by double-clicking may be set to correspond to functions of “zooming in the image” and “zooming out the image”, respectively. When the sensing result generated by the sensing unit 130A indicates that the user double clicks the virtual key 122A, the action determination unit 130A generates an action determination result corresponding to the virtual key 122A being triggered by double-clicking; when the sensing result generated by the sensing unit 130A indicates that the user double clicks the virtual key 122B, the action determination unit 130A generates an action determination result corresponding to the virtual key 122B being triggered by double-clicking.

FIG. 1(C) shows another exemplary virtual key configuration according to the present invention. The virtual key configuration depicted in FIG. 1(C) includes three virtual keys 124A, 124B and 124C, which respectively cover three different sub-regions of the touch sensing electrode group 120. For example, when the touch control electronic device 100 is in a function setting mode (a fourth operation mode), the virtual keys 124A, 124B and 124C (the fourth virtual key configuration) may be set to correspond to functions of “select”, “return to homepage” and “return to previous menu”, respectively.

In practice, the virtual key configurations in the touch control electronic device may be determined by a designer according to actual application requirements, and may be stored in advance in the memory 130C for the control module 130 to look up and refer to. Thus, given that the control module 130 learns which sub-region and how that sub-region of the touch sensing electrode group 120 is affected (e.g., single clicked, double clicked or slid along a predetermined direction) by the user finger, which of the virtual keys is triggered may be determined. On the other hand, after the user selects an operation mode, the current operation mode of the touch control electronic device 100 may be temporarily stored in the memory 130C to serve as a reference basis for the control module 130 to select the virtual key configuration.

It should be noted that, not only one lateral side of the touch control electronic device 100 can be disposed of the touch sensing electrode group 120. For example, the touch sensing electrode group 120 may include two portions, which may be disposed on the left and right sides of the touch control electronic devices 100 and designed to provide virtual keys in different quantities and having different functions, respectively. Further, through updating related software in the touch control electronic device 100, the quantity, position and trigger method of the virtual keys in the virtual key configurations may be adjusted. Compared to conventional mechanical keys, the virtual keys of the touch control electronic device 100 according to the present invention offer greater flexibilities. It should be noted that, the quantity, size and relative ratio of the virtual keys in the drawings are illustrative and are not to be construed as limitations to the scope of the present invention.

It should be noted that, if capacitive or resistive touch control technologies are adopted, it is possible that the touch sensing electrode group 120 be designed as being entirely enclosed in the housing of the touch control electronic device 100 and still be capable of providing the function of detecting a user touch. That is to say, in practice, it is possible that the position on the housing of the touch control electronic device 100 corresponding to the touch sensing electrode group 120 be made totally seamless. Thus, compared to devices adopting conventional mechanical keys, the touch control electronic device 100 according to the present invention provides not only flexibilities supporting different virtual key configurations in different operation modes but also better waterproofness, thereby reducing the malfunction rate caused by a seeped liquid to be more particularly suitable for wearable devices.

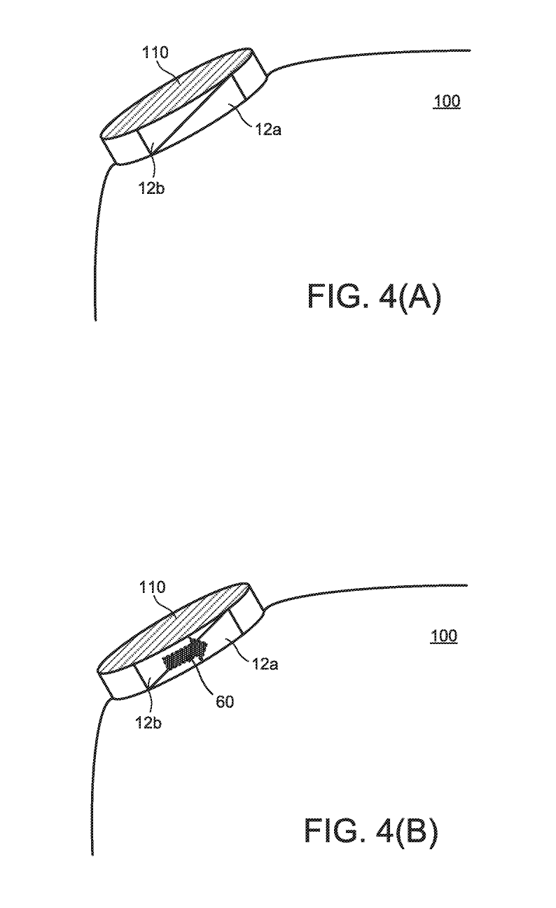

FIG. 3 shows a front schematic diagram of the touch control electronic device 100 according to an embodiment. In this embodiment, the touch control electronic device 100 further includes a physical key 140. When the control module 130 generates an action determination result associated with the touch sensing electrode group 120 (not shown, as located on a lateral side), whether the physical key 140 is pressed is further considered. For example, when the touch sensing electrode group 120 similarly detects a user gesture as a virtual arc drawn in a counterclockwise direction, the control module 130 generates one type of action determination result if the physical key 140 is pressed, or else it generates another type of action determination result if the physical key 140 is not pressed.

In one embodiment, the main display region 110 includes a plurality of main display region sensing electrodes, which is also a touch operation region. Further, when the control module 130 in the touch control electronic device 100 generates an action determination result associated with the touch sensing electrode group 120, whether the main display region 110 receives a user command is further considered. For example, when it is detected that the virtual key 124A on the touch sensing electrode group 120 is double clicked, the control module 130 generates one type of action determination result if a part of the main display region 110 is pressed, or else it generates another type of action determination result if that part of the main display region 110 is not pressed. In practice, when the main display region 110 is also a touch operation region, the main display region 110 and the touch sensing electrode group 120 may be designed to share the same control module. The control module 130 may be coupled to the touch operation region and the touch sensing electrode group 120, so as to detect respective touch conditions of the touch operation region and the touch sensing electrode group 120 to further generate corresponding determination results. In practice, the control module 130 may be implemented by a touch sensing chip.

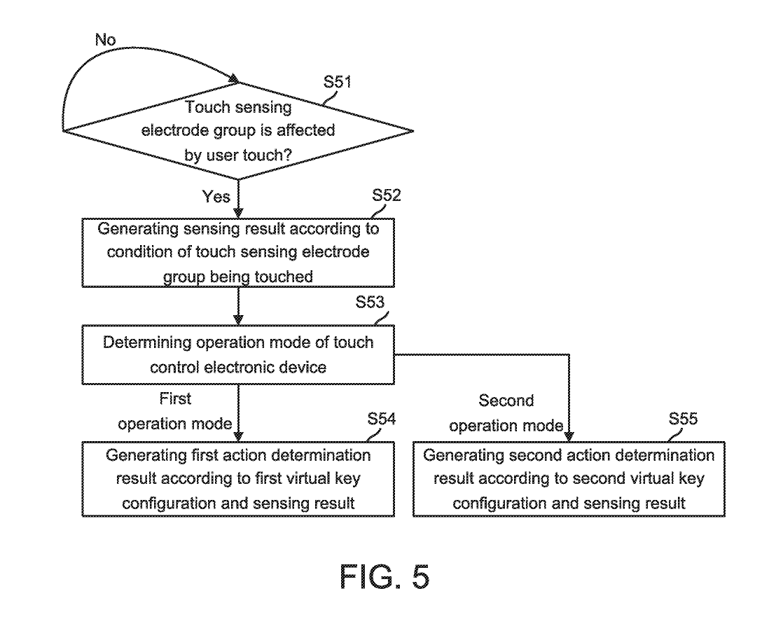

FIG. 4(A) shows an example of the touch sensing electrode group 120 including two sensing electrodes based on self-capacitive touch control technologies. The touch sensing electrode group 120 includes a first sensing electrode 12a and a second sensing electrode 12b, which are adjacent to each other with a gap in between. As shown in FIG. 4(A), each of the sensing electrodes 12a and 12b is a claw-like electrode. The claw width of the first sensing electrode 12a gradually reduces along a predetermined direction, and the claw width of the second sensing electrode 12b gradually reduces along a direction opposite the predetermined direction. The sensing electrode pair 12a and 12b jointly form a sensing region that is substantially a rectangle. In this embodiment, the control module 130 in the touch control electronic device 100 determines a position of a user touch according to a relative value of capacitance changes of the sensing electrodes 12a and 12b. For example, when it is detected that the capacitance change in the sensing electrode 12a continues increasing and the capacitance change in the sensing electrode 12b continues decreasing due to a user touch, the control module 130 may deduce that, a user gesture as a virtual straight line 60 drawn in the regions where the paired sensing electrode 12a and 12b are located may have appeared, as shown in FIG. 4(B). It should be noted that, as from the drawings, the electrode structure in FIG. 4(A) may coordinate with the change in shape of a border region contains non-straight lines, and has no difficulties in identifying the user gesture. Further, the electrode structure in FIG. 4(A), with each of the sensing electrodes 12a and 12b connects to the control module 130 via only one sensing wire, is capable of completing the required sensing operation while having a shape fits the main display region 110. That is to say, this embodiment may be completed with merely two sensing wires, and provides better performance in aspects of saving the internal space of the touch control electronic device and reducing interference between the sensing wires.

In practice, a difference in the humidity in an environment within a short period may cause vapor condensation on the surface of the touch control electronic device 100. For a device adopting self-capacitive touch control technologies, compared to a humidity-free situation, when moisture occurs between a user finger and the touch sensing electrode group 120, the self capacitance value detected by a backend detection circuit is greater. To prevent the moisture from affecting the detection result of the touch control electronic device 100, in one embodiment, the control module 130 in the touch control electronic device 100 further determines whether to cause the touch control electronic device 100 to enter a mist mode according to a mutual capacitance value between two sensing electrodes (e.g., the sensing electrodes 12a and 12b) included in the touch sensing electrode group 120. Compared to a humidity-free situation, the mutual capacitance value between the sensing electrodes 12a and 12b is greater. Thus, the control module 130 may determine whether to cause the touch control electronic device 100 to enter a mist mode according to whether the mutual capacitance value between the sensing electrodes 12a and 12b is higher than a predetermined mutual capacitance threshold. In one embodiment, when the touch control electronic device 100 enters a mist mode, a self capacitance threshold according to which whether the sensing electrodes 12a and 12b are touched by a user is determined is increased, so as to prevent touch control misjudgment caused by mist. It should be noted that, details for measuring the mutual capacitance value between any two sensing electrodes are generally known to one person skilled in the art, and shall be omitted herein.

In one embodiment, the touch control electronic device 100 further includes a prompting module disposed on a lateral side. The prompting module assists in providing related information of a position of a virtual key. For example, the lateral side of the touch control electronic device 100 may be implemented by a light pervious housing, and the prompting module may be a light emitting device disposed inside the housing of the touch control electronic device 100. In the first operation mode, the prompting module displays a group of first key patterns corresponding to the first virtual key configuration; in the operation mode, the prompting module displays a group of second key patterns corresponding to the second virtual key configuration.

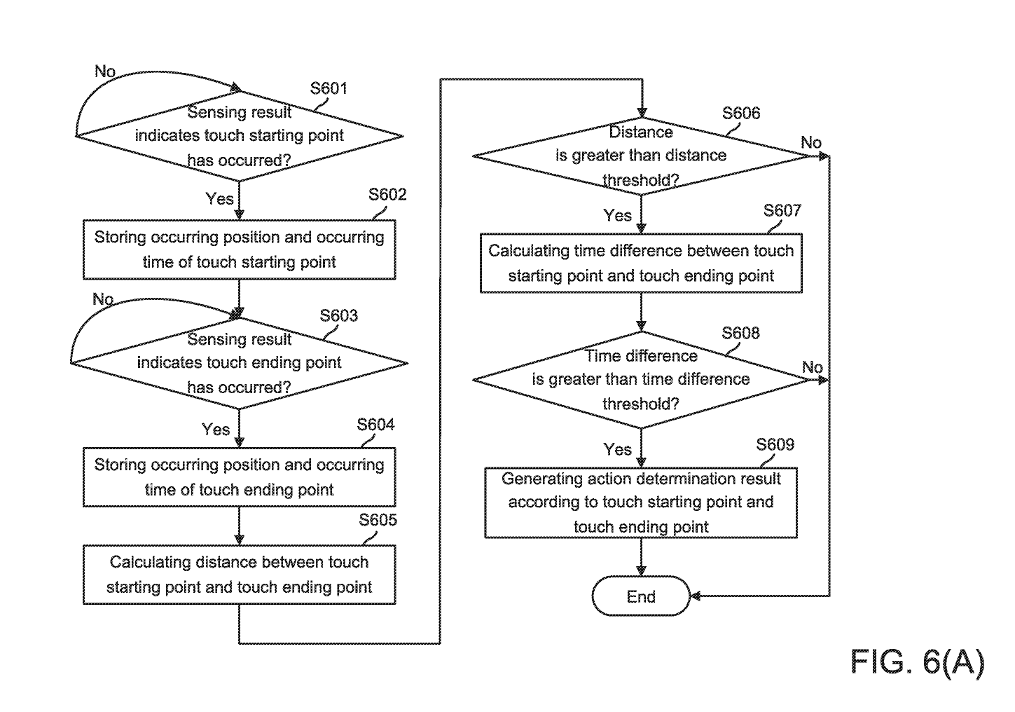

FIG. 5 shows a flowchart of a control method for a touch control electronic device according to another embodiment of the present invention. The touch control electronic device includes a main display region and a touch sensing electrode group. The main display region is disposed in the front of the touch control electronic device. The touch sensing electrode group is disposed on a lateral side of the touch control electronic device. Referring to FIG. 5, in step S51, it is determined whether the touch sensing electrode group is affected by a user touch. Step S51 is iterated when the determination result of step S51 is negative, or else step S52 is performed when the determination result of step S51 is affirmative. In step S52, a sensing result is generated according to a condition of the touch sensing electrode group being touched. In step S53, a current operation mode of the touch control electronic device is determined. Step S54 is performed when the determination result of step S53 indicates a first operation mode, or else step S55 is performed when the determination result of step S53 indicates a second operation mode. In step S54, a first action determination result is generated according to a first virtual key configuration and the sensing result.

In step S55, a second action determination result is generated according to a second virtual key configuration and the sensing result. The second virtual key configuration is different from the first virtual key configuration.

Step S54 and step S55 may be performed by the action determination unit 130B in FIG. 2. FIG. 6(A) and FIG. 6(B) show examples of processes of the action determination unit 130B in two different operation modes. The virtual key configuration corresponding to FIG. 6(A) is associated with the virtual segment drawn by the user touch at the touch sensing electrode group. In step S601, it is determined whether the sensing result generated by the sensing unit 130A indicates that a touch starting point occurs (no other touch point has occurred for a past period). Step S601 is iterated when the determination result of step S601 is negative, or else step S602 is performed. In step S602, the occurring position and the occurring time of the touch starting point are stored (e.g., stored in the memory 130C). In step S603, it is determined whether the sensing result generated by the sensing unit 130A indicates that a touch ending point occurs (a touch point stops occurring after the occurrence of a series of touch points). Step S603 is iterated when the determination result of step S603 is negative, or else step S604 is performed when the determination result of step S603 is affirmative. In step S604, the occurring position and the occurring time of the touch ending point are stored (e.g., stored in the memory 103C). In step S605, a distance between the touch starting point and the touch ending point is calculated (e.g., a linear distance is calculated according to coordinates). In step S606, it is determined whether the distance is greater than a predetermined distance threshold. When the determination result of step S606 is affirmative, step S607 is performed to calculate a time difference between occurring time points of the touch starting point and the touch ending point. In step S608, it is determined whether the time difference is greater than a predetermined time difference threshold. When the determination result of step S608 is affirmative, it means that the user touch forms an valid virtual segment, and step S609 is performed. In step S609, an action determination result is generated according to the touch starting point and the touch ending point. In contrast, when the determination result of step S606 or step S608 is negative, the current user touch is considered as invalid, and the process ends (step S601 may be re-started).

The virtual key configuration corresponding to FIG. 6(B) includes N virtual keys, e.g., the virtual keys 124A to 124C in FIG. 1(C). Assuming that i is an integral index between 1 and N. In step S651, the integral index i is set to 1. In step S652, a capacitance change corresponding to the i^{th} virtual key is checked according to the sensing result generated by the sensing unit 130A. In step S653, it is determined whether the capacitance change is greater than a predetermined threshold. When the determination result of step S653 is affirmative, step S654 is performed to generate an action determination result to report that the i^{th} virtual key is pressed. In step S655, i is set to i=i+1. In step S656, it is determined whether the current integral index i is smaller than or equal to N. When the determination result of step S656 is affirmative, step S652 is iterated, i.e., checking the capacitance change corresponding to the next virtual key. When the determination result of step S653 is negative, steps S655 and S656 are performed. When the determination result of step S656 is negative, it means that all of the N virtual keys are completely checked, and the process ends (step S651 may be re-started).

In practice, for example but not limited to, the action determination unit 130B may be implemented as a fixed and/or programmable digital logic circuit, including a programmable logic gate array, an application-specific integrated circuit (ASIC), a microcontroller, a microprocessor, a digital signal processor, or other necessary circuits. Further, the action determination unit 130B may also be designed to complete multiple tasks through executing processor commands stored in the memory 130C. The present invention does not limit the type of storage mechanism. The memory 130C may include one or multiple volatile or non-volatile memory devices, e.g., a random access semiconductor memory, a read-only memory, a magnetic and/or optical memory, or a flash memory.

One person skilled in the art can understand that, various operation modifications in the description associated with the touch control electronic device 100 are applicable to the control method in FIG. 5, and shall be omitted herein.

In the foregoing embodiments, by connecting only one sensing wire to each of two self-capacitive sensing electrodes (e.g., the sensing electrode pair 12a and 12b), the technology of sensing operation required can be completed. Moreover, the two self-capacitive sensing electrodes may be implemented on a lateral side of various types of touch control electronic devices. A touch control electronic device is further provided according to another embodiment of the present invention. The touch control electronic device includes a touch sensing electrode group and a control module. The touch sensing electrode group is disposed on a lateral side of the touch control electronic device, and includes a first sensing electrode and a second sensing electrode that are adjacent to each other with a gap in between. Each of the first sensing electrode and the second sensing electrode is a claw-like electrode. A claw width of the first sensing electrode gradually reduces along a predetermined direction. A claw width of the second sensing electrode gradually reduces along a direction opposite the predetermined direction. The control module is coupled to the first sensing electrode via one single first sensing wire, and is coupled to the second sensing electrode via one single second sensing wire. The control module generates a sensing result according to a condition of the touch sensing electrode group being touched.

The foregoing technology of determining whether to cause the electronic device to enter a mist mode is also applicable to various types of the touch control electronic devices including two adjacent sensing electrodes. A touch control electronic device is further provided according to another embodiment of the present invention. The touch control electronic device includes a touch sensing electrode group and a control module. The touch sensing electrode group includes a first sensing electrode and a second sensing electrode, which are adjacent by a gap in between. The control module is coupled to the touch sensing electrode group, and generates an action determination result according to a condition of the touch sensing electrode group being touched. The control module determines whether to cause the touch control electronic device to enter a mist mode according to a mutual capacitance value between the first sensing electrode and the second sensing electrode.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A touch control electronic device, comprising:
a main display region, disposed on the front side of the touch control electronic device;
a touch sensing electrode group, disposed on a lateral side of the touch control electronic device; and
a control module, coupled to the touch sensing electrode group, generating a sensing result according to a condition of the touch sensing electrode group being touched; in a first operation mode, the control module generating a first action determination result according to a first virtual key configuration and the sensing result; in a second operation mode, the control module generates a second action determination result according to a second virtual key configuration and the sensing result.

2. The touch control electronic device according to claim 1, wherein the first virtual key configuration and the second virtual key configuration differ by at least one of: a quantity of virtual keys, functions of virtual keys, sizes of virtual keys, positions of virtual keys and a trigger method of virtual keys.

3. The touch control electronic device according to claim 1, further comprising:
a physical key;
wherein the control module further refers to whether the physical key is pressed to generate the first action determination result.

4. The touch control electronic device according to claim 1, wherein the main display region comprises a plurality of main display region sensing electrodes, and the control module further refers to whether the plurality of main display region sensing electrodes receive a user command to generate the first action determination result.

5. The touch control electronic device according to claim 4, wherein the plurality of main display region sensing electrodes are further coupled to the control module, and the control module generates another sensing result according to a condition of the plurality of main display region sensing electrodes being touched.

6. The touch control electronic device according to claim 1, wherein the touch sensing electrode group comprises a first sensing electrode and a second sensing electrode that are adjacent to each other with a gap in between, each of the first sensing electrode and the second sensing electrode is a claw-like electrode, a claw width of the first sensing electrode gradually reduces along a predetermined direction, and a claw width of the second sensing electrode reduces along a direction opposite the predetermined direction.

7. The touch control electronic device according to claim 1, wherein the touch sensing electrode group comprises a first sensing electrode and a second sensing electrode, and the control module further determines whether to cause the touch control electronic device to enter a mist mode according to a mutual capacitance value between the first sensing electrode and the second sensing electrode.

8. The touch control electronic device according to claim 7, wherein when the touch control electronic device enters the mist mode, a self-capacitance threshold according to which whether the first sensing electrode or the second sensing electrode is touched by a user is determined is increased.

9. The touch control electronic device according to claim 1, further comprising:
a prompting module, disposed on the lateral side of the touch control electronic device, the prompting module displaying a group of first key patterns corresponding to the first virtual key configuration in the first operation mode, and displaying a group of second key patterns corresponding to the second virtual key configuration in the second operation mode.

10. A control method for a touch control electronic device, the touch control electronic device comprising a main display region and a touch sensing electrode group, the main display region disposed on the front side of the touch control electronic device, the touch sensing electrode group disposed on a lateral side of the touch control electronic device, the control method comprising:
a) generating a sensing result according to a condition of the touch control electronic device being touched;
b) in a first operation mode, generating a first action determination result according to a first virtual key configuration and the sensing result; and
c) in a second operation mode, generating a second action determination result according to a second virtual key configuration and the sensing result.

11. The control method according to claim 10, wherein the first virtual key configuration and the second virtual key configuration differ by at least one of: a quantity of virtual keys, functions of virtual keys, sizes of virtual keys, positions of virtual keys and a trigger method of virtual keys.

12. The control method according to claim 10, wherein the touch control electronic device further comprises a physical key, and step (a) further comprises referring to whether the physical key is pressed to generate the first action determination result.

13. The control method according to claim 10, wherein the main display region comprises a plurality of main display region sensing electrodes, and step (a) further comprises referring to whether the plurality of main display region sensing electrodes receive a user command to generate the first action determination result.

14. The control method according to claim 10, wherein step (a) further comprises generating the first action determination result according to a motion direction of a user touch.

15. The control method according to claim 11, wherein the touch sensing electrode group comprises a first sensing electrode and a second sensing electrode, the control method further comprising:
determining whether to cause the touch control electronic device to enter a mist mode according to a mutual capacitance value between the first sensing electrode and the second sensing electrode.

16. The control method according to claim 15, further comprising:
when the touch control electronic device enters the mist mode, increasing a self-capacitance threshold according to which whether the first sensing electrode or the second sensing electrode is touched by a user is determined in step (a).

17. The control method according to claim 10, further comprising:
in the first operation mode, displaying a group of first key patterns corresponding to the first virtual key configuration in the first operation mode; and
in the second operation mode, displaying a group of second key patterns corresponding to the second virtual key configuration in the second operation mode.

18. A touch control electronic device, comprising:
a touch sensing electrode group, disposed on the lateral side of the touch control electronic device, comprising a first sensing electrode and a second sensing electrode that are adjacent to each other with a gap in between, each of the first sensing electrode and the second sensing electrode being a claw-like electrode, a claw width of the first sensing electrode gradually reduces along a predetermined direction, a claw width of the second sensing electrode gradually reduces along a direction opposite the predetermined direction; and
a control module, coupled to the first sensing electrode and the second sensing electrode, generating a sensing result according to a condition of the touch sensing electrode group being touched.
